(19) United States
(12) Patent Application Publication
(10) Pub. No.: US 2026/0212703 A1
(43) Pub. Date: Jul. 23, 2026

(54) INFORMATION PROCESSING SYSTEM, INFORMATION PROCESSING METHOD, AND NON-TRANSITORY COMPUTER READABLE MEDIUM

(71) Applicant: NEC Corporation, Tokyo (JP)

(72) Inventor: Kosuke YOSHIMI, Tokyo (JP)

(73) Assignee: NEC Corporation, Tokyo (JP)

(21) Appl. No.: 19/138,794

(22) PCT Filed: Dec. 22, 2022
(86) PCT No.: PCT/JP2022/047318

§ 371 Date: Jun. 13, 2025

(51) Int. Cl. G06V 40/19; G06V 10/141

(52) U.S. Cl. CPC G06V 40/19; G06V 10/141

(57) ABSTRACT

An information processing system (100) includes an attribute information acquisition unit (112) and a projection condition determination unit (113). The attribute information acquisition unit (112) acquires attribute information of a target. The projection condition determination unit (113) determines a projection condition of first and second lighting fixtures (108a, 108b) projecting light onto the target for capturing an image of the target, based on the attribute information. The projection condition includes a lighting frequency of each of the first and second lighting fixtures (108a, 108b).

### Technical Field

This disclosure relates to an information processing system, information processing apparatus, information processing method, and a medium.

### BACKGROUND ART

Various technologies related to image capture for acquiring an iris recognition image are proposed.

For example, an iris recognition apparatus described in Patent Document 1 includes an iris camera and two lighting apparatuses 41 and 42. The two lighting apparatuses 41 and 42 are installed in such a way that the respective incident angles of emitted light relative to a target person T are different from each other. The iris camera captures an image of a target person T on whom light is projected from the lighting apparatus 42 but, on the other hand, not from the lighting apparatus 41.

For example, an iris recognition apparatus described in Patent Document 2 includes an image capture unit, an optical path bending unit, and a recognition processing unit. The image capture unit described in Patent Document 2 includes a first surface and a second surface along a plate surface and captures an image; and the optical axis of an optical system for the image capture accommodated between the first surface and the second surface of a door extends in a direction along the plate surface. The optical path bending unit described in Patent Document 2 is placed between the first surface and the second surface and within an image capture range of the image capture unit. The optical path bending unit causes the image capture unit to capture an image of the outside of the first window or the outside of the second window by bending an optical path for the image capture in the first window direction and the second window direction. The recognition processing unit described in Patent Document 2 executes iris recognition, based on a captured image captured by the image capture unit.

### RELATED DOCUMENT

### Patent Document

Patent Document 1: International Application Publication No. WO 2020/261424
Patent Document 2: Japanese Patent Application Publication No. 2017-0627567

### SUMMARY

### Technical Problem

An object of this disclosure is to improve the technologies described in the related documents.

### Solution to Problem

According to an aspect of the present invention, an information control system including:
an attribute information acquisition unit that acquires attribute information of a target; and
a projection condition determination unit that determines a projection condition of first to M-th lighting fixtures (where M is an integer equal to or greater than 2) projecting light for capturing an image of the target onto the target, based on the attribute information, wherein
the projection condition includes a lighting frequency of each of the first to M-th lighting fixtures
is provided.

According to an aspect of the present invention, an information processing apparatus including:
an attribute information acquisition unit that acquires attribute information of a target; and
a projection condition determination unit that determines a projection condition of first to M-th lighting fixtures (where M is an integer equal to or greater than 2) projecting light for capturing an image of the target onto the target, based on the attribute information, wherein
the projection condition includes a lighting frequency of each of the first to M-th lighting fixtures
is provided.

According to an aspect of the present invention, an information control method including, by one or more computers:
acquiring attribute information of a target; and
determining a projection condition of first to M-th lighting fixtures (where M is an integer equal to or greater than 2) projecting light for capturing an image of the target onto the target, based on the attribute information, wherein
the projection condition includes a lighting frequency of each of the first to M-th lighting fixtures
is provided.

According to an aspect of the present invention, a medium on which a program is recorded, the program causing one or more computers to execute:
acquiring attribute information of a target; and
determining a projection condition of first to M-th lighting fixtures (where M is an integer equal to or greater than 2) projecting light for capturing an image of the target onto the target, based on the attribute information, wherein
the projection condition includes a lighting frequency of each of the first to M-th lighting fixtures is provided.

### BRIEF DESCRIPTION OF THE DRAWINGS

FIG. 1 is a diagram illustrating an overview of an information processing system according to a first example embodiment.

FIG. 2 is a diagram illustrating an overview of an information processing apparatus according to the first example embodiment.

FIG. 3 is a flowchart illustrating an overview of information processing according to the first example embodiment.

FIG. 4 is a diagram illustrating a configuration example of the information processing system according to the first example embodiment.

FIG. 5 is a diagram illustrating a functional configuration example of an attribute information acquisition unit according to the first example embodiment.

FIG. 6 is a diagram illustrating a functional configuration example of a projection condition determination unit according to the first example embodiment.

FIG. 7 is a diagram illustrating a physical configuration example of the information processing apparatus according to the first example embodiment.

FIG. 8 is a flowchart illustrating an example of the information processing according to the first example embodiment.

FIG. 9 is a flowchart illustrating an example of the information processing according to the first example embodiment.

FIG. 10 is a flowchart illustrating an example of projection condition determination processing according to the first example embodiment.

FIG. 11 is a diagram illustrating a configuration example of an information processing system according to a second example embodiment.

FIG. 12 is a flowchart illustrating an example of information processing according to the second example embodiment.

FIG. 13 is a diagram illustrating a configuration example of an information processing system according to a third example embodiment.

FIG. 14 is a diagram illustrating a functional configuration example of a projection condition determination unit according to the third example embodiment.

FIG. 15 is a flowchart illustrating an example of information processing according to the third example embodiment.

FIG. 16 is a flowchart illustrating an example of projection condition determination processing according to the third example embodiment.

FIG. 17 is a diagram illustrating a configuration example of an information processing system according to a fourth example embodiment.

FIG. 18 is a flowchart illustrating an example of information processing according to the fourth example embodiment.

### EXAMPLE EMBODIMENT

Example embodiments of the present invention will be described below by using the drawings. Note that in every drawing, similar components are given similar signs, and description thereof is omitted as appropriate.

### First Example Embodiment

### Overview

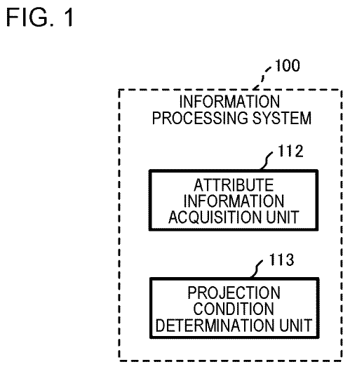

FIG. 1 is a diagram illustrating an overview of an information processing system 100 according to a first example embodiment. The information processing system 100 includes an attribute information acquisition unit 112 and a projection condition determination unit 113.

The attribute information acquisition unit 112 acquires attribute information of a target. The projection condition determination unit 113 determines a projection condition of first to M-th lighting fixtures (where M is an integer equal to or greater than 2) projecting light onto the target for capturing an image of the target, based on the attribute information. The projection condition includes the lighting frequency of each of the first to M-th lighting fixtures.

The information processing system 100 enables acquisition of a more satisfactory captured image of a target person.

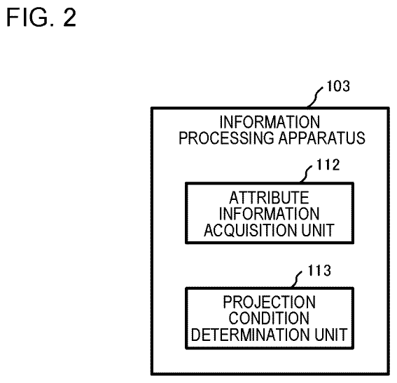

FIG. 2 is a diagram illustrating an overview of an information processing apparatus 103 according to the first example embodiment. The information processing apparatus 103 includes an attribute information acquisition unit 112 and a projection condition determination unit 113.

The attribute information acquisition unit 112 acquires attribute information of a target. The projection condition determination unit 113 determines a projection condition of first to M-th lighting fixtures (where M is an integer equal to or greater than 2) projecting light onto the target for capturing an image of the target, based on the attribute information. The projection condition includes the lighting frequency of each of the first to M-th lighting fixtures.

The information processing apparatus 103 enables acquisition of a more satisfactory captured image of a target person.

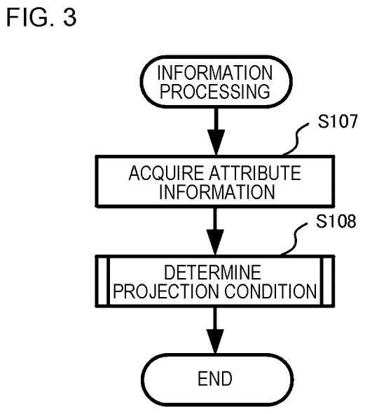

FIG. 3 is a flowchart illustrating an overview of information processing according to the first example embodiment.

The attribute information acquisition unit 112 acquires attribute information of a target (Step S107).

The projection condition determination unit 113 determines a projection condition of the first to M-th lighting fixtures (where M is an integer equal to or greater than 2) projecting light onto the target for capturing an image of the target, based on the attribute information (Step S108).

The projection condition includes the lighting frequency of each of the first to M-th lighting fixtures.

The information processing enables acquisition of a more satisfactory captured image of a target person.

Detailed examples of the information processing system 100, the information processing apparatus 103, the information processing method, and the like according to the first example embodiment will be described below.

### Details

In Patent Document 1 described above, an image of a target person T on whom light is projected from the lighting apparatus 42 but, on the other hand, not from the lighting apparatus 41 is captured. However, it may be difficult to acquire a satisfactory captured image of the target person T in a case where only one of the lighting apparatuses 41 and 42 is lit.

Patent Document 2 described above discloses a configuration for bending an optical path for image capture but does not disclose a configuration for acquiring a satisfactory captured image of the target person T.

An example of an object of this disclosure is to, in view of such circumstances, provide an information processing system, an information processing apparatus, an information processing method, a medium, and the like that resolve the issue of acquiring a more satisfactory captured image of a target person.

### Configuration Example of Information Processing System 100 According to First Example Embodiment

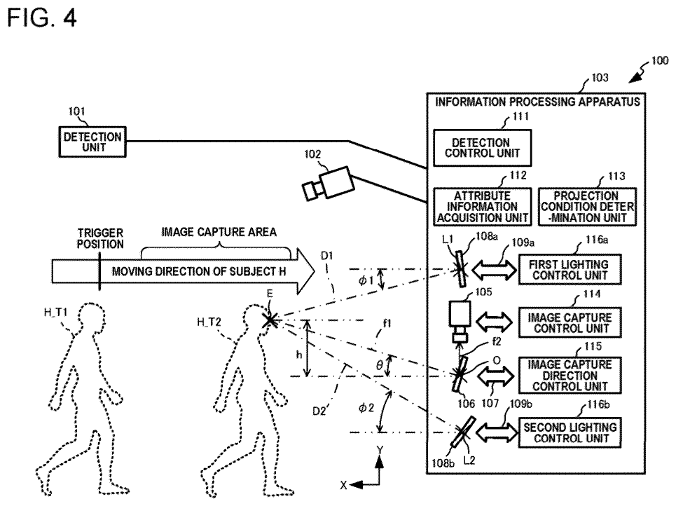

FIG. 4 is a diagram illustrating a configuration example of the information processing system 100 according to the first example embodiment. The information processing system 100 is a system for generating a target part image by capturing an image of a target in a predetermined image capture area.

A target according to the present example embodiment is a person. Note that, without being limited to the above, a target may be an animal such as a dog or a snake.

A target part image is an image including a predetermined part of a target. The present example embodiment will be described by using an example of a target part image being an iris image. The predetermined part in this case is an iris. For example, an iris image is an image including a predetermined one of the left and right irises or both the left and right irises. An iris image has only to include an iris and may include the white of the eye, an eyelid, an outer canthus, or an inner canthus. For example, an iris image is used in iris recognition being biometric recognition using the image.

In other words, the information processing system 100 according to the present example embodiment is a system generating an iris image by capturing a person in the predetermined image capture area. A person may be moving or be at a standstill in the predetermined image capture area. The present example embodiment will be described by using an example of the information processing system 100 generating an iris image by capturing an image of a person moving in the predetermined image capture area.

Note that, without being limited to an iris image, for example, a target part image may be a facial image the predetermined part of which is a face. For example, a facial image is preferably used in face recognition or the like. Further, a target part image may be an image used for a purpose other than biometric recognition.

The information processing system 100 includes a detection unit 101, a wide-area image capture apparatus 102, and the information processing apparatus 103.

The detection unit 101 detects a person passing through a predetermined trigger position. At a time when detecting a person passing through the trigger position, the detection unit 101 outputs a detection signal.

For example, the detection unit 101 may include an area sensor for detecting passage through a trigger position determined by a two-dimensional plane or a three-dimensional space or may include an infrared sensor for detecting passage through a linear trigger position. Further, the detection unit 101 may be configured with one sensor or a plurality of sensors. Note that the detection unit 101 may detect entry of a person into the trigger position.

The wide-area image capture apparatus 102 is an image capture apparatus for capturing an image of a person detected by the detection unit 101, that is, a person passing through the trigger position, according to the present example embodiment. For example, the wide-area image capture apparatus 102 is a camera.

The wide-area image capture apparatus 102 is configured to be able to capture an image the image capture range of which covers an area wider than that of an iris image. Thus, at a time when a target person passes through the trigger position, the wide-area image capture apparatus 102 generates a wide-area image of the person by capturing an image of the neighborhood of the trigger position.

A wide-area image is an image in which an area wider than the image capture range of an iris image is captured. A wide-area image desirably includes an iris image. Examples of a wide-area image according to the present example embodiment include a full-length image in which the whole body of a person is captured, a facial image in which the face of a person is captured, and a binocular image in which both eyes of a person are captured.

The wide-area image capture apparatus 102 may generate one wide-area image (i.e., a static image) or a plurality of wide-area images (i.e., a video). Wide-area images in the case of generating a video are frame images constituting the video.

### Functional Configuration Example of Information Processing Apparatus 103 According to First Example Embodiment

The information processing apparatus 103 is an apparatus for generating an iris image by capturing an image of a person moving in the predetermined image capture area. Note that, as described above, the information processing apparatus 103 may be an apparatus generating an iris image by capturing a person at a standstill in the predetermined image capture area.

As illustrated in FIG. 4, the information processing apparatus 103 includes an iris image capture apparatus 105, an image capture mirror 106, an image capture drive mechanism 107, first and second lighting fixtures 108a and 108b, and first and second lighting drive mechanisms 109a and 109b. Further, the information processing apparatus 103 includes a detection control unit 111, an attribute information acquisition unit 112, a projection condition determination unit 113, an image capture control unit 114, an image capture direction control unit 115, a first lighting control unit 116a, and a second lighting control unit 116b.

Aforementioned M is 2 in this configuration example. In other words, the present example embodiment will be described by using an example of the information processing system 100 including two sets of lighting fixtures 108a and 108b, lighting drive mechanisms 109a and 109b, and lighting control units 116a and 116b. Note that aforementioned M may be 3 or greater. In other words, the information processing system 100 may include three or more sets of lighting fixtures, lighting drive mechanisms, and lighting control units.

The iris image capture apparatus 105 is an image capture apparatus for capturing an image of an iris of a target person. Specifically, for example, the iris image capture apparatus 105 generates an iris image of a target person in the predetermined image capture area by capturing an image of the person. For example, the iris image capture apparatus 105 is a camera such as a near-infrared camera.

The image capture mirror 106 is a mirror for changing the image capture direction of the iris image capture apparatus 105. Specifically, the iris image capture apparatus 105 captures an image of an iris of a person through the image capture mirror 106.

The image capture mirror 106 according to the present example embodiment includes a flat mirror surface and is provided in such a way as to be rotatable around a rotation center O being the intersection of the rotation center in the image capture direction and the optical axis of an optical system included in the iris image capture apparatus 105. By rotating around the rotation center O, the image capture mirror 106 can change an elevation angle θ of the mirror surface relative to the horizontal direction. The elevation angle θ is also an elevation angle of the iris image capture apparatus 105 in the image capture direction. Note that the mirror surface included in the mirror 106 is not limited to a flat surface and, for example, may be a curved surface such as a convex surface or a concave surface.

The image capture drive mechanism 107 is a mechanism for changing the direction of the image capture mirror 106, such as the direction of the mirror surface of the mirror. Specifically, for example, the image capture drive mechanism 107 includes an image capture motor. The image capture motor is an example of a drive unit for changing the direction of the image capture mirror 106, such as the direction of the mirror surface of the mirror.

Each of the first and second lighting fixtures 108a and 108b projects light for the image capture drive mechanism 107 to capture an image onto a target person. The first and second lighting fixtures 108a and 108b are provided in such a way that the projection directions of the lighting fixtures toward the person are different from each other. The first and second lighting fixtures 108a and 108b according to the present example embodiment are provided side by side in the vertical direction (a Y-direction in FIG. 4). Thus, the first and second lighting fixtures 108a and 108b can project light onto the target person from above and from below the target person, respectively.

For example, each of the first and second lighting fixtures 108a and 108b according to the present example embodiment projects light from a light-emitting device provided on a substrate onto a target person. For example, the light-emitting device is a light emitting diode (LED). Examples of the light emitted by the light-emitting device include near-infrared rays but are not limited thereto.

The first and second lighting drive mechanisms 109a and 109b are mechanisms for changing the projection directions of the first and second lighting fixtures 108a and 108b, respectively, and are provided in association with the first and second lighting fixtures 108a and 108b, respectively. For example, the first and second lighting drive mechanisms 109a and 109b include first to M-th lighting motors, respectively, for changing the directions of substrates included in the first and second lighting fixtures 108a and 108b, respectively.

The lighting fixtures 108a and 108b according to the present example embodiment each include a flat light-emitting surface on which the light-emitting device is placed and are provided in such a way as to be rotatable around rotation centers L1 and L2, respectively. By rotating around the rotation center L1, the lighting fixture 108a can change an elevation angle φ1 of the light-emitting surface relative to the horizontal direction. Similarly, by rotating around the rotation center L2, the lighting fixture 108b can change an elevation angle φ2 of the light-emitting surface relative to the horizontal direction.

Note that the first and second lighting fixtures 108a and 108b may each project light from a light-emitting unit (e.g., an LED) onto a target person through an unillustrated lighting mirror. In this case, the first and second lighting drive mechanisms 109a and 109b each preferably change the direction of the lighting mirror.

At a time when acquiring a detection signal from the detection unit 101, the detection control unit 111 causes the wide-area image capture apparatus 102 to capture an image of the trigger position.

The attribute information acquisition unit 112 acquires attribute information of a target person. For example, the attribute information acquisition unit 112 acquires attribute information, based on a wide-area image generated by the wide-area image capture apparatus 102.

For example, attribute information may include the position of the eyes (an eye position) of a target person. For example, the attribute information may include information about at least one of the line-of-sight direction and the face-turning direction of the target. For example, the attribute information may include information about at least one of the height and a wearing article of the target person.

Examples of a wearing article include one or more of eyewear, a mask, headwear, and the like.

In a case where the wearing article is eyewear, examples of information about the wearing article of the target person include at least one of the position, the range, the angle, and the size of the eyewear on the face of the target person. In a case where the wearing article is a mask, examples of information about the wearing article of the target person include one or more of the shape type, the size, and the wearing position of the mask worn by the target person.

Examples of a shape type of a mask include one or more of a type the face-hiding ratio of which is a predetermined ratio, a type the face-hiding ratio of which is less than the predetermined ratio, a type the amount of protrusion of the nose part of which is equal to or greater than a predetermined amount, and a type the amount of protrusion is less than the predetermined amount.

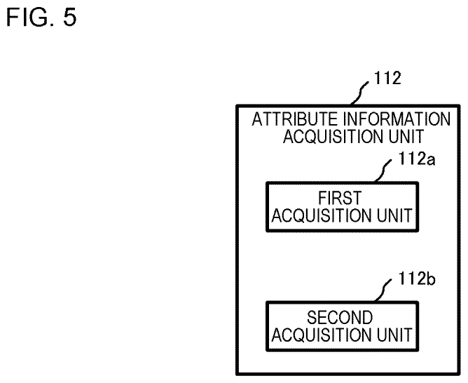

FIG. 5 is a diagram illustrating a functional configuration example of the attribute information acquisition unit 112 according to the first example embodiment. The attribute information acquisition unit 112 includes a first acquisition unit 112a and a second acquisition unit 112b.

The first acquisition unit 112a acquires attribute information of a target person, based on a wide-area image in which the person is captured. For example, attribute information acquired by the first acquisition unit 112a (the attribute information is hereinafter also referred to as “first attribute information”) is the position of the eyes of a person (the eye position). In other words, the first acquisition unit 112a estimates the eye position of a person captured in a wide-area image, based on the wide-area image.

A common technology such as pattern matching or a machine learning model may be employed in the technology for estimating an eye position by the first acquisition unit 112a. For example, the first acquisition unit 112a preferably inputs a wide-area image and outputs the eye position of a person captured in the wide-area image by using a first learning model. The first learning model is a machine learning model trained for estimating the eye position of a person captured in a wide-area image. Training data in which a ground truth label is given to a wide-area image in which a target model is captured are preferably used in learning of the first learning model. A target model is a target employed for learning and, for example, is a person captured in a wide-area image for learning.

The second acquisition unit 112b acquires attribute information of a target person, based on a wide-area image in which the person is captured.

For example, attribute information acquired by the second acquisition unit 112b (the attribute information is hereinafter also referred to as “second attribute information”) is information about at least one of a physical feature, the external appearance, and the state of the body of a target person. Specifically, for example, in a case where the first attribute information includes the eye position of a target person, the second attribute information preferably includes an attribute other than the eye position related to the person. Examples of a physical feature include a height. Examples of the external appearance include a wearing article. Examples of the state of the body include a line-of-sight direction and a face-turning direction.

A common technology such as pattern matching or a machine learning model may be employed in the technology for acquiring second attribute information by the second acquisition unit 112b. For example, the second acquisition unit 112b preferably inputs a wide-area image and outputs second attribute information of a person captured in the wide-area image by using a second learning model. The second learning model is a machine learning model trained for estimating second attribute information of a person captured in a wide-area image. Training data in which a ground truth label is given to a wide-area image in which a target model is captured are preferably used in learning of the second learning model.

Note that the first acquisition unit 112a and the second acquisition unit 112b may be configured by using a common machine learning model. In this case, for example, the attribute information acquisition unit 112 preferably inputs a wide-area image and outputs first attribute information (the eye position) and second attribute information of a person captured in the wide-area image by using the learning model. The learning model is a model trained for estimating first attribute information and second attribute information of a person captured in a wide-area image. Training data in which a ground truth label is given to a wide-area image in which a target model is captured are preferably used in learning of the learning model.

The projection condition determination unit 113 determines a projection condition of the first and second lighting fixtures 108a and 108b, based on attribute information.

The projection condition includes the lighting frequency of each of the first and second lighting fixtures 108a and 108b in image capture of a target person. For example, the projection condition may include a combination of the lighting frequencies of the first and second lighting fixtures 108a and 108b for the purpose of lighting the first and second lighting fixtures 108a and 108b exclusively and alternately. The timing at which lighting is switched in alternate lighting of the first and second lighting fixtures 108a and 108b may be random or periodic.

For example, the lighting frequency is preferably represented by the probability of each of the first and second lighting fixtures 108a and 108b being lit in each image capture in a case where an image of one person being one target is captured a plurality of times. It can be said that such a lighting frequency is the ratio of each of the first and second lighting fixtures 108a and 108b being lit in the plurality of image captures.

Specifically, for example, denoting the lighting probability (the lighting ratio) of the first lighting fixture 108a by p and the lighting probability (the lighting ratio) of the second lighting fixture 108b by q, the projection condition includes (p, q). Each of p and q is a real number greater than 0 and less than 1, and the total of p and q (i.e., the value of p+q) is 1.

Note that the projection condition may include not only a lighting state of lighting the first and second lighting fixtures 108a and 108b at different timings but also a lighting state of simultaneously lighting the lighting fixtures.

The projection condition determination unit 113 may determine a projection condition including a plurality of lighting patterns in a case where an image of one person being one target is captured a plurality of times. A lighting pattern is a combination of the respective lighting frequencies of the first and second lighting fixtures 108a and 108b.

The projection condition determination unit 113 may determine a projection condition including lighting frequencies causing the first and second lighting fixtures 108a and 108b to be in different lighting states in a case where an image of one person being one target is captured a plurality of times (i.e., for each frame image of a video the subject of which is the one person). A lighting state includes one or more of lighting or extinction, projection power (brightness) in the case of the lighting fixture being lit, and the like.

The projection condition determination unit 113 may determine a projection condition based on attribute information by using a first relation. The first relation is a relation among attribute information of a target model, the lighting states of the first and second lighting fixtures 108a and 108b, and a recognition-enabled ratio being the ratio of successful iris recognitions using an iris image in which the target model is captured as a subject.

For example, the projection condition determination unit 113 may hold attribute-lighting frequency information associating attribute information with a combination of the respective lighting frequencies of the first and second lighting fixtures 108a and 108b. The attribute-lighting frequency information is information predetermined based on the first relation and, for example, may be a table associating attribute information with a combination of lighting frequencies.

The attribute-lighting frequency information may be determined by various methods. For example, the attribute-lighting frequency information may be predetermined based on a first relation acquired by trials. For example, the attribute-lighting frequency information may be predetermined by statistically processing a first relation acquired by trials.

The projection condition may further include the projection direction of light from each of the first and second lighting fixtures 108a and 108b. The projection condition determination unit 113 in this case preferably determines the projection condition, based on an estimated eye position.

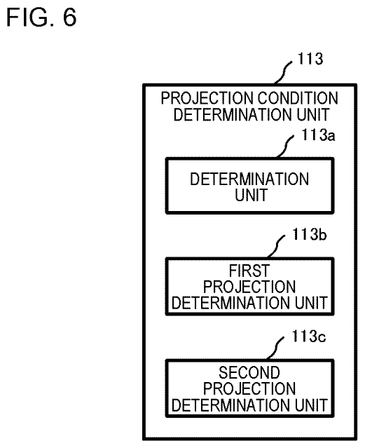

FIG. 6 is a diagram illustrating a functional configuration example of the projection condition determination unit 113 according to the first example embodiment. The projection condition determination unit 113 includes a determination unit 113a, a first projection determination unit 113b, and a second projection determination unit 113c.

The determination unit 113a determines whether attribute information of a target person is included in the attribute-lighting frequency information. Specifically, for example, the determination unit 113a determines whether attribute information acquired by the attribute information acquisition unit 112 is included in the attribute-lighting frequency information.

In a case where the determination unit 113a determines inclusion in the attribute-lighting frequency information, the first projection determination unit 113b determines a projection condition including the lighting frequency of each of the first and second lighting fixtures 108a and 108b associated with attribute information of a target person.

In a case where the determination unit 113a determines noninclusion in the attribute-lighting frequency information, the second projection determination unit 113c determines a predetermined default condition to be the projection condition.

For example, the content of the default condition is to cause each of the first and second lighting fixtures 108a and 108b to project light onto a subject person at the same lighting frequency. Note that the content of the default condition is not limited to the above.

The image capture control unit 114 controls image capture by the iris image capture apparatus 105. For example, the image capture control unit 114 causes the iris image capture apparatus 105 to capture an image of a target person moving in the predetermined image capture area.

Specifically, for example, the image capture control unit 114 causes the iris image capture apparatus 105 to capture an image of a person while the person passes through the predetermined area, for example, on foot. Thus, the iris image capture apparatus 105 generates a plurality of iris images (i.e., an iris video) of a person moving in the predetermined image capture area. The iris images are frame images constituting the iris video.

The image capture direction control unit 115 controls the image capture direction of the iris image capture apparatus 105, based on an estimated eye position. For example, the image capture direction control unit 115 controls the image capture direction of the iris image capture apparatus 105 by controlling the image capture motor.

The first lighting control unit 116a and the second lighting control unit 116b control projection of light from the first and second lighting fixtures 108a and 108b, respectively, in accordance with a determined projection condition. Thus, the first lighting control unit 116a and the second lighting control unit 116b light the first and second lighting fixtures 108a and 108b at lighting frequencies based on the projection condition.

Further, in accordance with the determined projection condition, the first lighting control unit 116a and the second lighting control unit 116b control the projection directions of light from the first and second lighting fixtures 108a and 108b by controlling the first and second lighting drive mechanisms 109a and 109b, respectively. For example, the first and second lighting control units 116a and 116b control the first and second lighting drive mechanisms 109a and 109b by controlling the first to M-th lighting motors, respectively.

The functional configuration example of the information processing system 100 according to the first example embodiment has been mainly described thus far. From here onward, a physical configuration example of the information processing system 100 according to the first example embodiment will be described.

### Physical Configuration Example of Information Processing Apparatus 103

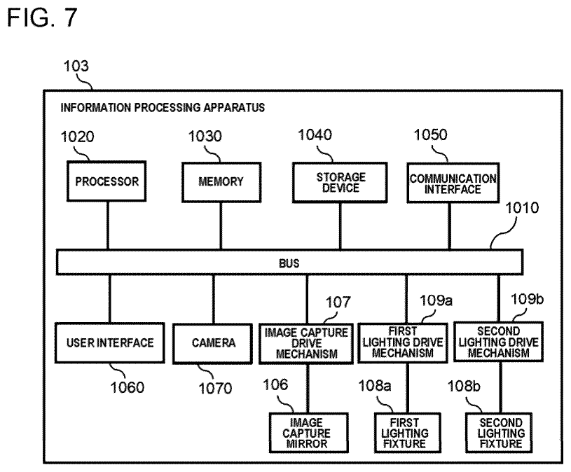

FIG. 7 is a diagram illustrating a physical configuration example of the information processing apparatus 103 according to the first example embodiment. For example, the information processing apparatus 103 physically includes a bus 1010, a processor 1020, a memory 1030, a storage device 1040, a communication interface 1050, a user interface 1060, and a camera 1070.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a hard disk drive (HDD), a solid-state drive (SSD), a memory card, a read-only memory (ROM), or the like. The storage device 1040 stores program modules for providing functions of the information processing apparatus 103. By reading each program module into the memory 1030 and executing the program module by the processor 1020, each function related to the program module is provided.

The communication interface 1050 is an interface for connecting the information processing apparatus 103 to a communication line.

Examples of the user interface 1060 include a touch panel, a keyboard, and a mouse as interfaces for a user to input information, and a liquid crystal panel and an organic electro-luminescence (EL) panel as interfaces for providing information to the user.

The camera 1070 is configured with an image pickup device, an optical system such as a lens, a control circuit for the aforementioned components, and the like and provides the iris image capture apparatus 105.

As illustrated in FIG. 7, the information processing apparatus 103 further includes the image capture mirror 106, the image capture drive mechanism 107, the first and second lighting fixtures 108a and 108b, and the first and second lighting drive mechanisms 109a and 109b. The physical configurations of the aforementioned components have been described above, and therefore, description thereof is omitted here.

The information processing apparatus 103 is preferably accommodated and integrally configured in one enclosure. Note that the physical configuration of the information processing apparatus 103 is not limited to the above. For example, one or both of the detection unit 101 and the wide-area image capture apparatus 102 may be further integrally configured with the information processing apparatus 103. Further, the information processing apparatus 103 may be configured with a plurality of physically divided apparatuses. Functions and physical members to be included in each apparatus in this case may be determined as appropriate.

The configuration example of the information processing system 100 according to the first example embodiment has been described thus far. From here onward, an operation example of the information processing system 100 according to the first example embodiment will be described.

### Operation of Information Processing System 100 According to First Example Embodiment

The information processing system 100 executes information processing for generating a target part image by capturing an image of a target moving in the predetermined image capture area. As described above, a target is a person, and a target part image is an iris image, according to the present example embodiment. The following description will use this example.

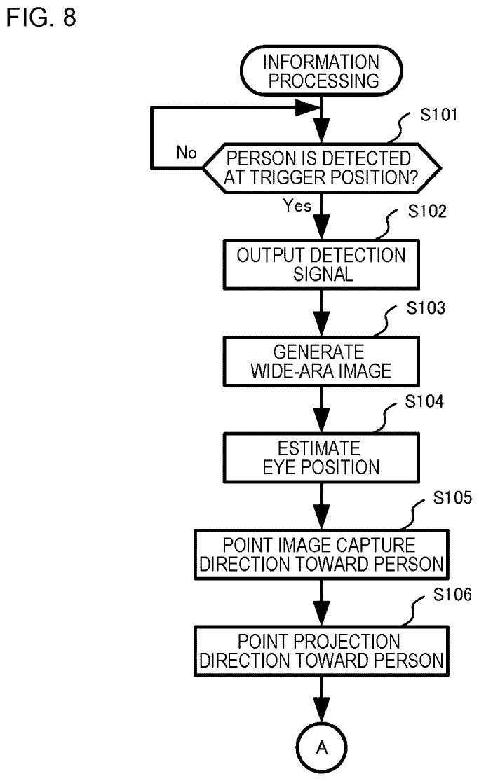

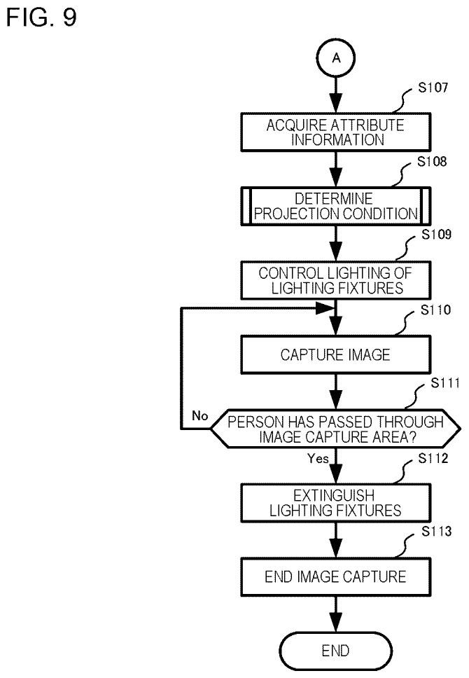

FIGS. 8 and 9 are flowcharts illustrating an example of information processing according to the first example embodiment. The information processing according to the present example embodiment is processing for generating an iris image by capturing an image of a person moving in the predetermined image capture area. For example, the information processing system 100 preferably executes the information processing repeatedly during operation of the system.

For example, at a time when a person passes through the trigger position, the detection unit 101 detects the person at the trigger position (Step S101). In the case of not detecting a person (Step S101: No), the detection unit 101 repeatedly executes Step S101 and stands by until a person passes through the trigger position.

In the case of detecting a person (Step S101: Yes), the detection unit 101 outputs a detection signal to the information processing apparatus 103 (Step S102).

At a time when acquiring the detection signal output in Step S102, the detection control unit 111 causes the wide-area image capture apparatus 102 to capture an image of the trigger position. Thus, the wide-area image capture apparatus 102 generates a wide-area image of the person passing through the trigger position (Step S103).

At a time when acquiring the wide-area image generated in Step S103 from the wide-area image capture apparatus 102, the first acquisition unit 112a estimates the eye position of the person captured in the acquired wide-area image, based on the wide-area image (Step S104).

Specifically, for example, the first acquisition unit 112a acquires the eye position of the person captured in the wide-area image by using the first learning model with the wide-area image as an input.

The image capture direction control unit 115 controls rotation of the image capture mirror 106 by controlling the image capture drive mechanism 107, based on the eye position estimated in Step S104. Thus, the image capture direction control unit 115 points the image capture direction of the iris image capture apparatus 105 toward an iris of the person (Step S105).

The first lighting control unit 116a and the second lighting control unit 116b control the first and second lighting drive mechanisms 109a and 109b associated with the respective lighting control units, based on the eye position estimated in Step S104. Thus, the first lighting control unit 116a and the second lighting control unit 116b point the projection directions of the first and second lighting fixtures 108a and 108b toward the person (e.g., the iris area) by rotating the substrates constituting the first and second lighting fixtures 108a and 108b (Step S106).

FIG. 9 is referred to.

At a time when acquiring the wide-area image generated in Step S103 from the wide-area image capture apparatus 102, the second acquisition unit 112b acquires attribute information of the person captured in the acquired wide-area image (second attribute information), based on the wide-area image (Step S107).

Specifically, for example, the second acquisition unit 112b acquires the second attribute information of the person captured in the wide-area image by using the second learning model with the wide-area image as an input.

The projection condition determination unit 113 determines a projection condition of the first and second lighting fixtures 108a and 108b, based on the attribute information acquired in Step S107 (Step S108).

Specifically, for example, the projection condition determination unit 113 determines the projection condition, based on the second attribute information acquired in Step S107. Note that the projection condition determination unit 113 may determine the projection condition, based on the second attribute, and the first attribute information (the eye position) estimated in Step S104.

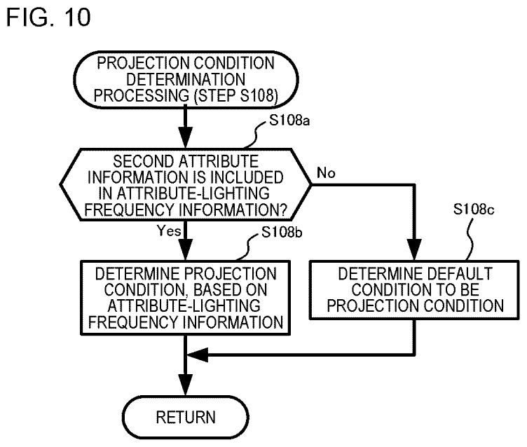

FIG. 10 is a flowchart illustrating an example of projection condition determination processing (Step S108) according to the first example embodiment.

The determination unit 113a determines whether the second attribute information acquired in Step S107 is included in the attribute-lighting frequency information (Step S108a).

In a case where the second attribute information is determined to be included in the attribute-lighting frequency information (Step S108a: Yes), the first projection determination unit 113b determines the projection condition, based on the attribute-lighting frequency information (Step S108b), and returns to the information processing.

Specifically, for example, the first projection determination unit 113b acquires a combination of lighting frequencies associated with the second attribute information acquired in Step S107 from the attribute-lighting frequency information. The first projection determination unit 113b determines the acquired combination of lighting frequencies to be the projection condition.

For example, as described above, the second attribute information has only to be information about at least one of the height, a wearing article, the line-of-sight direction, and the face-turning direction of a target person. Examples of a wearing article may include eyewear, a mask, and headwear.

### Example of Attribute-Lighting Frequency Information

For example, the attribute-lighting frequency information associates an attribute “wearing headwear and the height being equal to or less than a first threshold value (short)” with a lighting frequency “set the frequency of the lighting fixture 108b the projection angle φ2 of which is directed upward relative to the horizontal direction to be greater than a reference value.” Thus, darkening of an iris image can be prevented by strengthening light from below.

For example, the reference value is the lighting frequency in the default condition. For example, a lighting frequency included in the attribute-lighting frequency information may be represented by the ratio to or an amount to be increased or decreased from the reference value.

For example, the attribute-lighting frequency information associates an attribute “eyewear slipping below the eye position in excess of a threshold value” with a lighting frequency “set the frequency of the lighting fixture 108a the projection angle φ1 of which is directed downward relative to the horizontal direction to be greater than a reference value.” Thus, darkening of an iris image can be prevented by strengthening light from above.

For example, an attribute “a mask being a three-dimensional type and the mouth being hidden by the mask and the height being greater than a second threshold value (tall)” is associated with a lighting frequency “set the frequency of the lighting fixture 108b the projection angle φ2 of which is directed upward relative to the horizontal direction to be greater than the reference value.” Thus, darkening of an iris image can be prevented by strengthening light from below.

For example, a three-dimensional-type mask refers to a mask shaped in such a way that the amount of protrusion of the nose part of the mask is equal to or greater than a predetermined value. For example, the amount of protrusion of the nose part of the mask is the amount of protrusion of the nose part in the height direction of the nose of a person wearing the mask. The height direction of the nose is also a direction perpendicular to the face-turning direction. Further, for example, a reference point of the amount of protrusion may be a part not hidden by the mask, such as the forehead or an inner canthus.

For example, an attribute “the height being equal to or greater than the first threshold value and equal to or less than the second threshold value (medium) and wearing eyewear” is associated with a lighting frequency “light the lighting fixtures 108a and 108b evenly and alternately.” In a case where whether light from above or light from below affects the image quality of an iris image as noise is unknown in the case of such an attribute, an iris image that is highly likely to enable execution of iris recognition can be acquired by projecting light equally from both of the lighting fixtures 108a and 108b.

Noise refers to an iris area in an iris image being hidden due to the lighting fixture 108a or 108b, reflected light, or the like appearing on the eyeball surface, an eyewear lens, and/or the like. Noise may affect an iris image in such a way as to make execution of iris recognition difficult. Such noise is also referred to as lighting reflection noise or the like.

For example, an attribute “the line-of-sight direction or the face-turning direction pointing above the horizontal direction and a predetermined range” is associated with a lighting frequency “the frequency of the lighting fixture 108a the projection angle φ1 of which is directed downward relative to the horizontal direction is set to be greater than the reference value.” Thus, darkening of an iris image can be prevented by strengthening light from above.

For example, an attribute “the line-of-sight direction or the face-turning direction pointing below the horizontal direction and the predetermined range” is associated with a lighting frequency “the frequency of the lighting fixture 108b the projection angle φ2 of which is directed upward relative to the horizontal direction is greater than the reference value.” Thus, darkening of an iris image can be prevented by strengthening light from below.

FIG. 10 is referred to again.

In a case where the second attribute information is determined not to be included in the attribute-lighting frequency information (Step S108a: No), the second projection determination unit 113c determines the default condition to be the projection condition (Step S108c) and returns to the information processing.

FIG. 9 is referred to again.

The first lighting control unit 116a and the second lighting control unit 116b control lighting of the first and second lighting fixtures 108a and 108b in accordance with the projection condition determined in Step S108 (Step S109).

Specifically, for example, it is assumed that the projection condition is (p, q). As described above, the total of p and q is 1, and each of p and q is a real number greater than 0 and less than 1. There are various methods for controlling lighting of the first and second lighting fixtures 108a and 108b in accordance with such a projection condition.

More specifically, for example, one of the first lighting control unit 116a and the second lighting control unit 116b may include a random number generator generating a random number greater than 0 and less than 1. Then, in a case where the value generated by the random number generator is equal to or less than p, the first lighting control unit 116a may light the first lighting fixture 108a, and in a case where the value generated by the random number generator is greater than p, the second lighting control unit 116b may light the second lighting fixture 108b. At this time, in a case where one of the first and second lighting fixtures 108a and 108b is lit, the other of the lighting fixtures 108a and 108b is preferably extinguished. Thus, the first lighting fixture 108a and the second lighting fixture 108b can be lit at the probability p and the probability q, respectively.

For example, in a case where p and q represent an equal probability 1/M, the first lighting control unit 116a and the second lighting control unit 116b may select lighting fixtures 108a and 108b to be lit only from lighting fixtures 108a and 108b that are unlit in the past M captures. M is the number of the lighting fixtures 108a and 108b and is 2 in the present example embodiment. Thus, each of the first lighting fixture 108a and the second lighting fixture 108 b can be lit alternately in random order with the equal probability 1/M.

Further, specifically, for example, the first lighting control unit 116a and the second lighting control unit 116b may control the projection power of each of the first and second lighting fixtures 108a and 108b. More specifically, for example, the first lighting control unit 116a and the second lighting control unit 116b may control the projection power of each of the first and second lighting fixtures 108a and 108b in such a way that the brightness of light projected on a subject person is constant for each image capture according to optical path lengths D1 and D2 to the person.

FIG. 4 is referred to.

The optical path length D1 is the distance from the first lighting fixture 108a to the eye position of a person. L1 denotes coordinates representing the position of the rotation center of the first lighting fixture 108a. As illustrated in FIG. 4, the coordinate system is an x-y Cartesian coordinate system with the rotation center O of the image capture mirror 106 as the origin, and the x-y plane passes through the eye position, the rotation center O, and the rotation center of each of the lighting fixtures 108a and 108b.

The optical path length D2 is the distance from the second lighting fixture 108b to the eye position of the person. L2 denotes coordinates representing the position of the rotation center of the second lighting fixture 108b.

As for a focal distance f, a relation f=f1+f2 holds. Note that f is found from the focal distance at which the iris image capture apparatus 105 focuses. Further, f2 is the distance between the iris image capture apparatus 105 and the rotation center of the image capture mirror 106, and therefore, f2 is known from the placement relation between the two. Accordingly, f1 can be found.

The coordinates E(x, y) of the eye position can be represented by (d, h). Note that d is (f12−h2)\hat{ }(½), where “\hat{ }” represents a power. The elevation angle θ of the image capture direction can be represented by arcsin(h/f1). The elevation angle φi of the projection direction of each of the lighting fixtures 108a and 108b can be represented by arcsin(li/d). The optical path length Di can be represented by a Euclidean distance (|Li−E|). Note that i is 1 or 2.

In a case where the elevation angle θ of the image capture direction is indirectly given, the height h of the eye position is f1×sin θ, and therefore, the value of the parameter can be found from the aforementioned relational expression.

FIG. 9 is referred to again.

The image capture control unit 114 causes the iris image capture apparatus 105 to capture an image (Step S110). Thus, the iris image capture apparatus 105 generates an iris image of the person.

Specifically, for example, the image capture control unit 114 causes the iris image capture apparatus 105 to capture an image of the person on whom light is projected by the first and second lighting fixtures 108a and 108b at a predetermined frame rate. Thus, the image capture control unit 114 can capture an image of a person on whom light is projected in a lighting state based on attribute information (second attribute information in the present example embodiment). Therefore, an iris image that is highly likely to enable execution of iris recognition can be acquired.

The image capture control unit 114 determines whether the person has passed through the image capture area (Step S111).

Specifically, for example, the image capture control unit 114 determines whether the person has passed through the image capture area, based on the iris image generated in Step S110. For example, in a case where the degree of focus of the iris image is equal to or less than a threshold value, the image capture control unit 114 determines that the person has passed through the image capture area. In a case where the degree of focus of the iris image is greater than the threshold value, the image capture control unit 114 determines that the person is passing through the image capture area.

In the case of determining that the person is passing through the image capture area (Step S111: No), the image capture control unit 114 repeatedly executes Step S110. Thus, image capture of the iris can be continued until the person passes through the image capture area.

In the case of determining that the person has passed through the image capture area (Step S111: Yes), the image capture control unit 114 causes the iris image capture apparatus 105 to end the image capture (Step S113) and ends the information processing.

Repeated execution of such information processing during operation of the information processing system 100 enables acquisition of an iris image by image capture of an iris of a person passing through the image capture area. Then, for example, output of the iris image to a recognition apparatus (unillustrated) performing recognition by using an iris image enables iris recognition.

### Advantageous Effect

As described above, the information processing system 100 according to the first example embodiment includes the attribute information acquisition unit 112 and the projection condition determination unit 113. The attribute information acquisition unit 112 acquires attribute information of a target. The projection condition determination unit 113 determines a projection condition of the first and second lighting fixtures 108a and 108b projecting light onto the target for capturing an image of the target, based on the attribute information. The projection condition includes the lighting frequency of each of the first and second lighting fixtures 108a and 108b.

Thus, each of the first and second lighting fixtures 108a and 108b can project light at a lighting frequency based on the attribute information of the target. Therefore, more suitable light for acquiring a satisfactory captured image (an iris image in the present example embodiment) can be projected compared with the case of projecting light onto a target irrespective of attribute information of the target. Accordingly, a more satisfactory captured image of the target person can be acquired.

The first and second lighting fixtures 108a and 108b according to the first example embodiment are provided in such a way that the projection directions of the lighting fixtures toward a target are different from each other. The projection condition determination unit 113 determines a projection condition including lighting frequencies causing the first and second lighting fixtures 108a and 108b to be in different lighting states in each of a plurality of image captures of a target.

Thus, light can be projected from the first and second lighting fixtures 108a and 108b in different manners in each image capture. A satisfactory captured image (an iris image in the present example embodiment) is more likely to be acquired compared with the case of light being projected in a constant manner from the first and second lighting fixtures 108a and 108b. Accordingly, a more satisfactory captured image of the target person can be acquired.

The projection condition determination unit 113 according to the first example embodiment determines a projection condition based on attribute information of a target model by using the first relation among the attribute information, the lighting states of the first and second lighting fixtures 108a and 108b, and the recognition-enabled ratio being the ratio of successful recognitions using an image captured with the target model as a subject.

Thus, a projection condition based on the attribute information is determined by using the first relation, and therefore a satisfactory captured image (an iris image in the present example embodiment) is more likely to be acquired. Accordingly, a more satisfactory captured image of the target person can be acquired.

The projection condition determination unit 113 according to the first example embodiment holds attribute-lighting frequency information associating attribute information with the lighting frequency of each of the first and second lighting fixtures 108a and 108b. The attribute-lighting frequency information is information predetermined based on the first relation.

Thus, a projection condition based on the attribute information can be determined by using the attribute-lighting frequency information predetermined based on the first relation. Therefore, a satisfactory captured image (an iris image in the present example embodiment) is more likely to be acquired. Accordingly, a more satisfactory captured image of a target person can be acquired.

The attribute-lighting frequency information according to the first example embodiment is information predetermined based on the first relation acquired by trials or information predetermined by statistically processing the first relation.

Thus, a projection condition based on attribute information can be determined by using the attribute-lighting frequency information predetermined based on the first relation. Therefore, a satisfactory captured image (an iris image in the present example embodiment) is more likely to be acquired. Accordingly, a more satisfactory captured image of a target person can be acquired.

The projection condition determination unit 113 according to the first example embodiment includes the determination unit 113a, the first projection determination unit 113b, and the second projection determination unit 113c.

The determination unit 113a determines whether attribute information of a target is included in the attribute-lighting frequency information. In the case of determining inclusion in the attribute-lighting frequency information, the first projection determination unit 113b determines a projection condition including a lighting frequency associated with the attribute information of the target. In the case of determining noninclusion in the attribute-lighting frequency information, the second projection determination unit 113c determines a predetermined default condition to be the projection condition. The content of the default condition is to cause the first and second lighting fixtures 108a and 108b to project light onto the target at the same lighting frequency.

Thus, light can be projected onto a target with the default condition as the projection condition in a case where attribute information of a target is not defined in the attribute-lighting frequency information. In a case where whether light from the first lighting fixture 108a or light from the second lighting fixture 108b affects the image quality of an iris image as noise is unknown, a satisfactory captured image (the iris image in the present example embodiment) is more likely to be acquired by projecting light equally from both of the lighting fixtures 108a and 108b. Accordingly, a more satisfactory captured image of the target person can be acquired.

The attribute information acquisition unit 112 according to the first example embodiment includes the first acquisition unit 112a. The first acquisition unit 112a estimates the eye position of a target, based on an image in which the target is captured. The attribute information includes the eye position of the target.

Thus, light from the first and second lighting fixtures 108a and 108b can be projected onto the eye position of the target, and the image capture direction can be pointed toward the eye position of the target. Accordingly, a more satisfactory captured image of the target person can be acquired.

The attribute information acquisition unit 112 according to the first example embodiment includes the second acquisition unit 112b. The second acquisition unit 112b acquires attribute information of a target, based on an image in which the target is captured. The attribute information further includes information about at least one of the height and a wearing article of the target.

In general, the effect of noise appearing in a captured image (an iris image in the present example embodiment) differs according to attribute information. Projection of light from the first and second lighting fixtures 108a and 108b at lighting frequencies based on such attribute information enables projection of light onto a target at lighting frequencies resistant to appearance of noise in a captured image. Accordingly, accordingly, a more satisfactory captured image of the target person can be acquired.

A wearing article according to the first example embodiment is eyewear. Information about a wearing article of a target includes at least one of the position, the range, the angle, and the size of the eyewear on the face of the target.

Thus, in a case where the target wears eyewear, light can be projected onto the target at lighting frequencies resistant to appearance of noise in a captured image. Accordingly, a more satisfactory captured image of the target person can be acquired.

A wearing article according to the first example embodiment is a mask. Information about a wearing article of a target includes the shape type of mask worn by the target.

Thus, in a case where the target wears a mask, light can be projected at lighting frequencies resistant to appearance of noise in a captured image target. Accordingly, a more satisfactory captured image of the target person can be acquired.

Attribute information according to the first example embodiment includes information about at least one of the line-of-sight direction and the face-turning direction of a target.

Thus, light can be projected in such a way that light is projected onto the front of the face of the target, based on at least one of the line-of-sight direction and the face-turning direction of the target, and light can be projected onto the target at lighting frequencies resistant to appearance of noise in a captured image. Accordingly, a more satisfactory captured image of the target person can be acquired.

The information processing system 100 according to the first example embodiment further includes the iris image capture apparatus 105 for capturing an image of an iris of a target through the image capture mirror 106 and the first and second lighting fixtures 108a and 108b provided in such a way that the projection directions toward a target are different from each other.

Such a configuration enables acquisition of an angular bias of the lighting fixtures 108a and 108b enabling suppression of noise appearing in a captured image, while achieving compactification of the information processing system 100.

An angular bias refers to the projection directions of a plurality of lighting fixtures being misaligned relative to the image capture surface. It is generally known that projection of light onto the image capture surface by a plurality of lighting fixtures having an angular bias enables noise reduction.

Accordingly, a more satisfactory captured image of the target person can be acquired with a compact configuration.

The information processing system 100 according to the first example embodiment further includes the image capture direction control unit 115 that controls the image capture direction of the iris image capture apparatus 105, based on an estimated eye position.

Thus, the image capture direction can be pointed toward the eye position of a target. Accordingly, a more satisfactory captured image of the target person can be acquired.

The information processing system 100 according to the first example embodiment further includes the image capture mirror 106 for changing the image capture direction of the iris image capture apparatus 105 and the image capture drive mechanism 107 for changing the direction of the image capture mirror 106. The image capture drive mechanism 107 includes the image capture motor for changing the direction of the image capture mirror 106. The image capture direction control unit 115 controls the image capture direction of the iris image capture apparatus 105 by controlling the image capture motor.

Thus, by capturing an image through the image capture mirror 106, placement of the iris image capture apparatus 105 can be flexibly designed, and compactification of the information processing system 100 can be achieved. Accordingly, a more satisfactory captured image of a target person can be acquired while compactification is being achieved.

The information processing system 100 according to the first example embodiment further includes the first lighting control unit 116a and the second lighting control unit 116b that control the first and second lighting drive mechanisms 109a and 109b in accordance with a determined projection condition. The projection condition determination unit 113 determines a projection condition including the projection direction of light from each of the first and second lighting fixtures 108a and 108b, based on an estimated eye position.

Thus, light from the first and second lighting fixtures 108a and 108b can be projected onto the eye position of a target. Accordingly, a more satisfactory captured image of the target person can be acquired.

The information processing system 100 according to the first example embodiment further includes the first and second lighting drive mechanisms 109a and 109b for changing the respective projection directions of the first and second lighting fixtures 108a and 108b. Each of the first and second lighting fixtures 108a and 108b projects light from the light-emitting device provided on the substrate or light from the light-emitting unit through the lighting mirror onto a target. The first and second lighting drive mechanisms 109a and 109b respectively include the first and second lighting motors for changing the respective directions of the substrates or the lighting mirrors. The first lighting control unit 116a and the second lighting control unit 116b respectively control the projection directions of the first and second lighting drive mechanisms 109a and 109b by controlling the first and second lighting motors.

Thus, the projection direction can be controlled by changing the angle of the substrate or the lighting mirror. Therefore, placement of the first and second lighting fixtures 108a and 108b can be flexibly designed, and compactification of the information processing system 100 can be achieved. Accordingly, a more satisfactory captured image of the target person can be acquired while compactification is being achieved.

The information processing apparatus 103 according to the first example embodiment includes the attribute information acquisition unit 112 and the projection condition determination unit 113. The attribute information acquisition unit 112 acquires attribute information of a target. The projection condition determination unit 113 determines a projection condition of the first and second lighting fixtures 108a and 108b projecting light onto the target for capturing an image of the target, based on the attribute information. The projection condition includes the lighting frequency of each of the first to M-th lighting fixtures 108a and 108b.

Thus, light from each of the first and second lighting fixtures 108a and 108b can be projected with lighting frequencies based on the attribute information of the target. Therefore, more suitable light for acquiring a satisfactory captured image (an iris image in the present example embodiment) can be projected compared with the case of projecting light onto the target irrespective of the attribute information of the target. Accordingly, a more satisfactory captured image of the target person can be acquired.

### Second Example Embodiment

An example of determining a projection condition by using a machine learning model will be described in the present example embodiment. Points different from the first example embodiment will be mainly described in the present example embodiment for simplification of description.

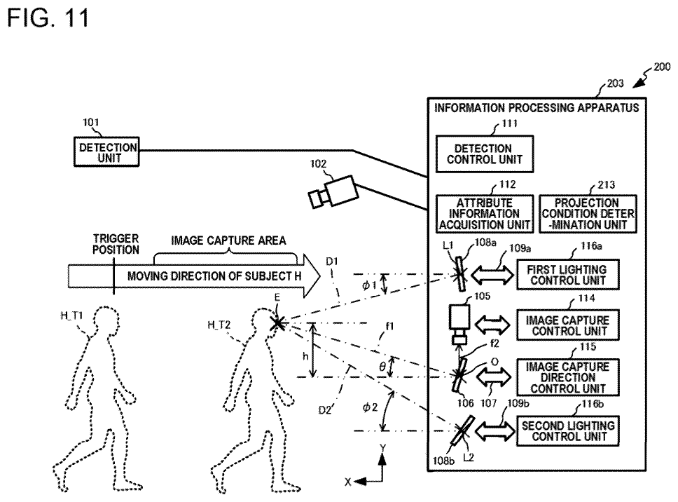

FIG. 11 is a diagram illustrating a configuration example of an information processing system 200 according to a second example embodiment. The information processing system 200 includes a projection condition determination unit 213 replacing the projection condition determination unit 113 according to the first example embodiment. Except for the above, the information processing system 200 is preferably configured similarly to the information processing system 100 according to the first example embodiment.

The projection condition determination unit 213 determines a projection condition of first and second lighting fixtures 108a and 108b, based on attribute information, similarly to the projection condition determination unit 113 according to the first example embodiment. The projection condition determination unit 213 according to the present example embodiment determines a projection condition by using a trained machine learning model.

Specifically, for example, the projection condition determination unit 213 determines a projection condition for a target person by using a projection condition determination model with attribute information as an input.

The projection condition determination model is a machine learning model trained for finding a projection condition of the first and second lighting fixtures 108a and 108b for a target person.

A projection condition output by the projection condition determination model includes at least a lighting frequency vector. A lighting frequency vector is a vector including the respective lighting frequencies of the first and second lighting fixtures 108a and 108b as elements.

The projection directions of the first and second lighting fixtures 108a and 108b in a projection condition are preferably determined by a method similar to that according to the first example embodiment. Note that the projection directions of the first and second lighting fixtures 108a and 108b may be determined by using the projection condition determination model. In this case, a projection condition output from the projection condition determination model includes the lighting frequency vector and the projection directions of the first and second lighting fixtures 108a and 108b.

For example, the projection condition determination model learns a function outputting at least a lighting frequency vector by using a neural network or the like. Training data in which a ground truth label is given to attribute information of a target model are preferably used in learning of the projection condition determination model.

For example, ground truth labels may include not only a positive example but also a negative example. Examples of a positive example include a lighting frequency vector enabling recognition using an iris image. Examples of a negative example include a lighting frequency vector making recognition using an iris image difficult due to the effect of noise or the like.

Note that the projection condition determination model used by the projection condition determination unit 213 is not limited to the above. For example, the projection condition determination unit 213 may determine a projection condition for a target by using a projection condition determination model with attribute information and an iris image as inputs or only an iris image as an input.

Training data in which ground truth labels are given to attribute information of a target model and an iris image or training data in which a ground truth label is given to an iris image are preferably used in learning of the projection condition determination model.

The information processing system according to the present example embodiment may be physically configured similarly to the information processing system 100 according to the first example embodiment.

### Operation of Information Processing System According to Second Example Embodiment

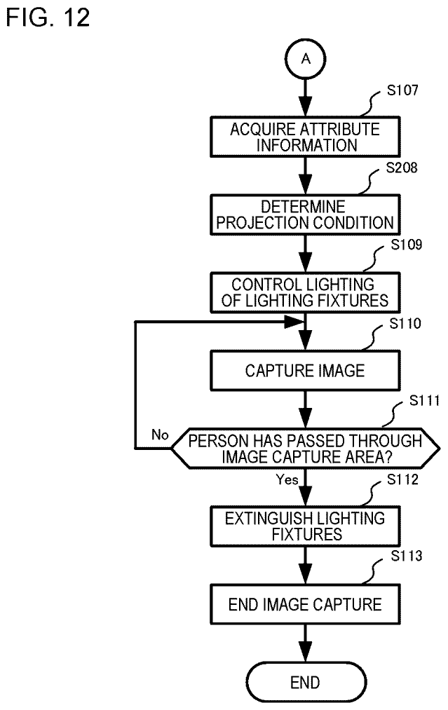

FIG. 12 is a flowchart illustrating an example of information processing according to the second example embodiment. The information processing according to the present example embodiment includes Steps S101 to 106 similar to those in the first example embodiment (see FIG. 8). FIG. 12 corresponds to the flowchart illustrated in FIG. 9 out of the flowcharts illustrating an example of the information processing according to the first example embodiment.

Subsequently to Step S107 similar to that in the first example embodiment, the projection condition determination unit 213 determines a projection condition for a person by using a projection condition determination model with the attribute information acquired in Step S107 as an input (Step S208).

Subsequently, Steps S109 to 113 similar to those in the first example embodiment are executed.

The information processing according to the present example embodiment is also preferably executed repeatedly during operation of the information processing system 200, similarly to the first example embodiment. Thus, an iris image can be acquired by capturing an image of an iris of a person passing through an image capture area. Then, for example, iris recognition can be performed by outputting the iris image to a recognition apparatus (unillustrated) performing recognition by using an iris image.

### Advantageous Effect

As described above, the projection condition determination unit 213 according to the second example embodiment determines a projection condition for a person by using a projection condition determination model for finding a projection condition of the first and second lighting fixtures 108a and 108b for the person with attribute information as an input.

Since a projection condition based on attribute information is thus determined by using a machine learning model, a satisfactory captured image (an iris image in the present example embodiment) is more likely to be acquired. Accordingly, a more satisfactory captured image of a target person can be acquired.

### Third Example Embodiment

An example of determining a projection condition, based on attribute information and environmental information, will be described in the present example embodiment. Points different from the first example embodiment will be mainly described in the present example embodiment for simplification of description.

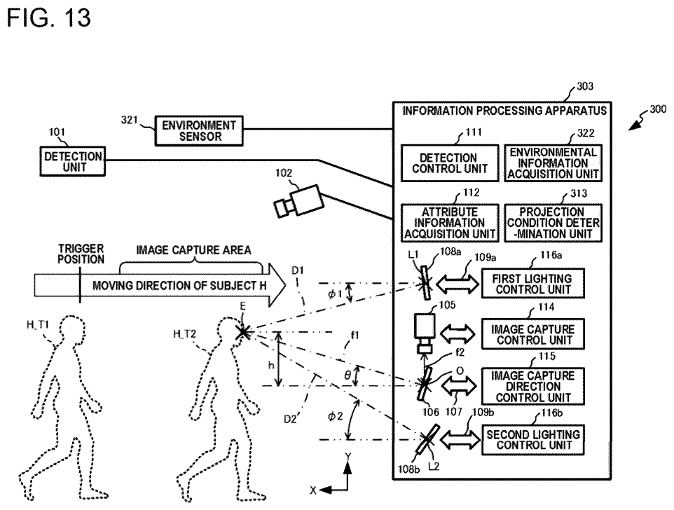

FIG. 13 is a diagram illustrating a configuration example of an information processing system 300 according to a third example embodiment. The information processing system 300 includes a projection condition determination unit 313 replacing the projection condition determination unit 113 according to the first example embodiment. The information processing system 300 further includes an environment sensor 321 and an environmental information acquisition unit 322. Except for the above, the information processing system 300 is preferably configured similarly to the information processing system 100 according to the first example embodiment.

The environment sensor 321 is a sensor detecting environmental information in a case where an image of a target person is captured. The environmental information includes at least one of the state of outdoor light into a target area, the weather, and the like.

Examples of outdoor light include sunlight and light entering from a window. Examples of the state of outdoor light into a target area include at least one of backlight, front light, and oblique light. Examples of the environment sensor 321 detecting the state of outdoor light include an optical sensor. Examples of the environment sensor 321 detecting the weather include a sensor for detecting the outdoor brightness and a sensor for detecting raindrops. Note that there may be a plurality of environment sensors 321.

For example, the environmental information acquisition unit 322 acquires environmental information from the environment sensor 321. Note that, for example, the environmental information acquisition unit 322 may acquire environmental information from an external apparatus providing environmental information, such as the weather, through a communication network or the like.

The projection condition determination unit 313 determines a projection condition of first and second lighting fixtures 108a and 108b, based on attribute information and environmental information.

The projection condition determination unit 313 may determine a projection condition based on attribute information and environmental information by using a second relation. The second relation is a relation among attribute information of a target model, environmental information, the lighting states of the first and second lighting fixtures 108a and 108b, and a recognition-enabled ratio being the ratio of successful iris recognitions using an iris image in which the target model is captured as a subject.

For example, the projection condition determination unit 313 may hold attribute-environment-lighting frequency information associating attribute information with environmental information and a combination of the respective lighting frequencies of the first and second lighting fixtures 108a and 108b. The attribute-environment-lighting frequency information is information predetermined based on the second relation and, for example, may be a table associating attribute information with environmental information and a combination of lighting frequencies.

The attribute-environment-lighting frequency information may be determined by various methods. For example, the attribute-environment-lighting frequency information may be predetermined based on a second relation acquired by trials. For example, the attribute-environment-lighting frequency information may be predetermined by statistically processing the second relation acquired by trials.

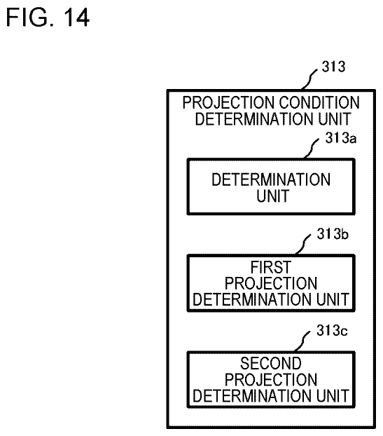

FIG. 14 is a diagram illustrating a functional configuration example of the projection condition determination unit 313 according to the third example embodiment. The projection condition determination unit 313 includes a determination unit 313a, a first projection determination unit 313b, and a second projection determination unit 313c. The functions of the units mostly correspond to those acquired by replacing the attribute-lighting frequency information in the first example embodiment with the attribute-environment-lighting frequency information, as will be described below.

The determination unit 313a determines whether a combination of attribute information of a target person and environmental information in a case where an image of the target is captured is included in the attribute-environment-lighting frequency information. Specifically, for example, the determination unit 113a determines whether a combination of attribute information acquired by the attribute information acquisition unit 112 and environmental information acquired by the environmental information acquisition unit 322 is included in the attribute-environment-lighting frequency information.

In a case where the determination unit 113a determines inclusion in the attribute-environment-lighting frequency information, the first projection determination unit 113b determines a projection condition including the lighting frequencies of the first and second lighting fixtures 108a and 108b associated with the combination of the attribute information of the target person and the environmental information in a case where an image of the target is captured.

In a case where the determination unit 113a determines noninclusion in the attribute-environment-lighting frequency information, the second projection determination unit 113c determines a predetermined default condition to be the projection condition. The content of the default condition may be similar to that according to the first example embodiment.

The information processing system according to the present example embodiment may be physically configured similarly to the information processing system 100 according to the first example embodiment.

### Operation of Information Processing System According to Third Example Embodiment

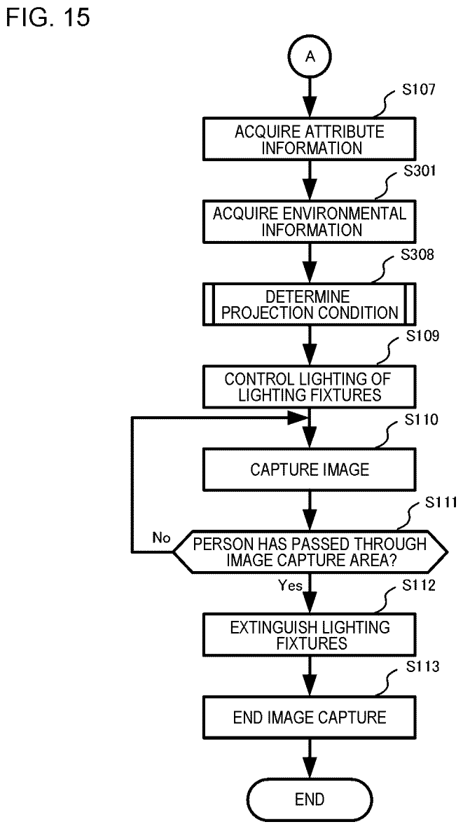

FIG. 15 is a flowchart illustrating an example of information processing according to the third example embodiment. The information processing according to the present example embodiment includes Steps S101 to 106 similar to those in the first example embodiment (see FIG. 8). FIG. 15 corresponds to the flowchart illustrated in FIG. 9 out of the flowcharts illustrating an example of the information processing according to the first example embodiment.

Subsequently to Step S107 similar to that in the first example embodiment, for example, the environmental information acquisition unit 322 acquires environmental information from the environment sensor 321 (Step S301).

The projection condition determination unit 313 determines a projection condition, based on second attribute information acquired in Step S107 and the environmental information acquired in Step S301. Note that the projection condition determination unit 313 may determine a projection condition, based on the second attribute, the environmental information, and first attribute information (an eye position) estimated in Step S104.

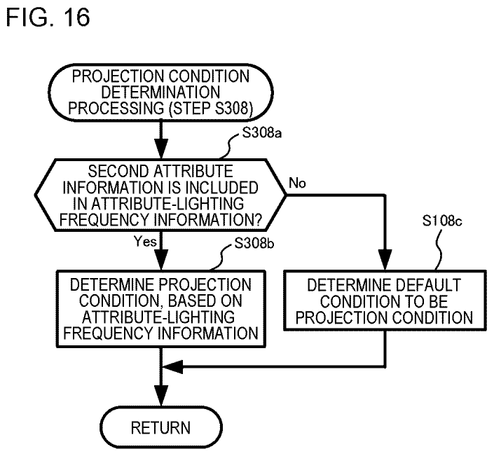

FIG. 16 is a flowchart illustrating an example of projection condition determination processing (Step S308) according to the third example embodiment.

The determination unit 313a determines whether a combination of the second attribute information acquired in Step S107 and the environmental information acquired in Step S301 is included in the attribute-environment-lighting frequency information (Step S308a).

In a case where the combination of the second attribute information and the environmental information is determined to be included in the attribute-environment-lighting frequency information (Step S308a: Yes), the first projection determination unit 313b determines a projection condition, based on the attribute-environment-lighting frequency information (Step S308b), and returns to the information processing.

Specifically, for example, the first projection determination unit 313b acquires a combination of lighting frequencies associated with the combination of the second attribute information acquired in Step S107 and the environmental information acquired in Step S301 from the attribute-environment-lighting frequency information. The first projection determination unit 313b determines the acquired combination of lighting frequencies to be the projection condition.

In a case where the combination of the second attribute information and the environmental information is determined not to be included in the attribute-environment-lighting frequency information (Step S308a: No), the second projection determination unit 313c determines a default condition to be the projection condition, similarly to the first example embodiment (Step S108c), and returns to the information processing.

Subsequently, as illustrated in FIG. 15, Steps S109 to 113 similar to those in the first example embodiment are executed.

The information processing according to the present example embodiment is also preferably executed repeatedly during operation of the information processing system 300, similarly to the first example embodiment. Thus, an iris image can be acquired by capturing an image of an iris of a person passing through an image capture area. Then, for example, iris recognition can be performed by outputting the iris image to a recognition apparatus (unillustrated) performing recognition by using an iris image.

### Advantageous Effect

As described above, the projection condition determination unit 313 according to the third example embodiment determines a projection condition, based on attribute information and an image capture environment.

Thus, a projection condition can be determined by further using environmental information, and therefore, a satisfactory captured image (an iris image in the present example embodiment) is more likely to be acquired. Accordingly, a more satisfactory captured image of a target person can be acquired.

### Fourth Example Embodiment

An example of determining a projection condition by using a machine learning model with attribute information and environmental information as inputs will be described in the present example embodiment. Points different from the first example embodiment will be mainly described in the present example embodiment for simplification of description.

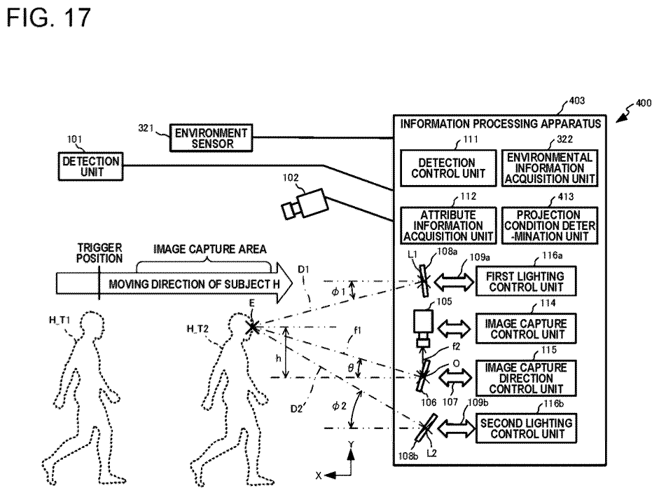

FIG. 17 is a diagram illustrating a configuration example of an information processing system 400 according to a fourth example embodiment. The information processing system 400 includes a projection condition determination unit 413 replacing the projection condition determination unit 113 according to the first example embodiment. The information processing system 300 further includes an environment sensor 321 and an environmental information acquisition unit 322 similar to those according to the third example embodiment. Except for the above, the information processing system 300 is preferably configured similarly to the information processing system 100 according to the first example embodiment.

The projection condition determination unit 413 determines a projection condition of first and second lighting fixtures 108a and 108b, based on attribute information and environmental information, similarly to the projection condition determination unit 313 according to the third example embodiment. The projection condition determination unit 413 according to the present example embodiment determines a projection condition by using a trained machine learning model.

Specifically, for example, the projection condition determination unit 413 determines a projection condition for a target person by using a projection condition determination model with attribute information and environmental information as inputs.

The projection condition determination model is a machine learning model trained for finding a projection condition of the first and second lighting fixtures 108a and 108b for a target person, similarly to that according to the third example embodiment. An output from the projection condition determination model according to the present example embodiment may be similar to that according to the third example embodiment. Specifically, a projection condition output by the projection condition determination model includes at least a lighting frequency vector.

For example, the projection condition determination model learns a function outputting at least a lighting frequency vector by using a neural network or the like, similarly to the third example embodiment. Training data in which a ground truth label is given to attribute information of a target model are preferably used in learning of the projection condition determination model. For example, ground truth labels may include not only a positive example but also a negative example.

Note that the projection condition determination model used in the projection condition determination unit 413 is not limited to the above. For example, inputs to the projection condition determination model may be attribute information, environmental information, and an iris image and may be environmental information and an iris image. Training data in which ground truth labels are given to attribute information of a target model, environmental information, and an iris image or training data in which ground truth labels are given to usual information and an iris image are preferably used in learning of the projection condition determination model.

The information processing system according to the present example embodiment may be physically configured similarly to the information processing system 100 according to the first example embodiment.

### Operation of Information Processing System According to Fourth Example Embodiment

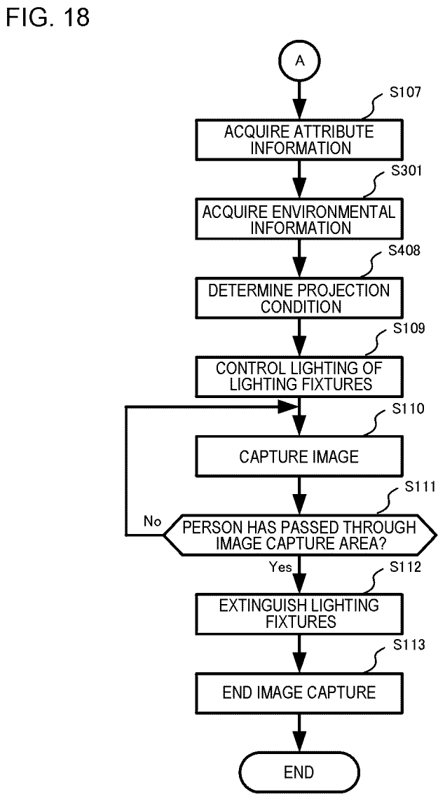

FIG. 18 is a flowchart illustrating an example of information processing according to the fourth example embodiment. The information processing according to the present example embodiment includes Steps S101 to 106 similar to those in the first example embodiment (see FIG. 8). FIG. 18 corresponds to the flowchart illustrated in FIG. 9 out of the flowcharts illustrating an example of the information processing according to the first example embodiment.

Subsequently to Step S107 similar to that in the first example embodiment and Step S301 similar to that in the third example embodiment, the projection condition determination unit 413 determines a projection condition for a person (Step S408).

Specifically, for example, the projection condition determination unit 413 determines a projection condition for a person by using the projection condition determination model with the attribute information acquired in Step S107 and the environmental information acquired in Step S301 as inputs.

Subsequently, Steps S109 to 113 similar to those in the first example embodiment are executed.

The information processing according to the present example embodiment is also preferably executed repeatedly during operation of the information processing system 400, similarly to the first example embodiment. Thus, an iris image can be acquired by capturing an image of an iris of a person passing through an image capture area. Then, for example, iris recognition can be performed by outputting the iris image to a recognition apparatus (unillustrated) performing recognition by using an iris image.

### Advantageous Effect

As described above, the projection condition determination unit 413 according to the fourth example embodiment determines a projection condition for a person by using a projection condition determination model for finding a projection condition of the first and second lighting fixtures 108a and 108b for the person with attribute information and environmental information as inputs.

Thus, a projection condition is determined by using a machine learning model with environmental information as an input in addition to attribute information, and therefore, a satisfactory captured image (an iris image in the present example embodiment) is more likely to be acquired. Accordingly, a more satisfactory captured image of a target person can be acquired.

While the example embodiments of the present invention and the modified examples thereof have been described above with reference to the drawings, the example embodiments are exemplifications of the present invention, and various configurations other than those described above may be employed.

Further, while a plurality of processes (processing) are described in a sequential order in each of a plurality of flowcharts used in the aforementioned description, the execution order of processes executed in each example embodiment is not limited to the order of description. The order of the illustrated processes may be modified without affecting the content in each example embodiment. Further, the aforementioned example embodiments and modified examples may be combined without contradicting each other.

The whole or part of the example embodiments disclosed above may also be described as, but not limited to, the following supplementary notes.
1. An information control system including:
   an attribute information acquisition unit that acquires attribute information of a target; and
   a projection condition determination unit that determines a projection condition of first to M-th lighting fixtures (where M is an integer equal to or greater than 2) projecting light for capturing an image of the target onto the target, based on the attribute information, wherein
   the projection condition includes a lighting frequency of each of the first to M-th lighting fixtures.
2. The information control system according to supplementary note 1, wherein
   the first to M-th lighting fixtures are provided in such a way that projection directions of the lighting fixtures toward the target are different from each other, and
   the projection condition determination unit determines the projection condition causing the first to M-th lighting fixtures to be in different lighting states in each of a plurality of image captures of the target.
3. The information control system according to supplementary note 1 or 2, wherein
   the projection condition determination unit determines the projection condition based on the attribute information by using a relation among attribute information of a target model, lighting states of the first to M-th lighting fixtures, and a recognition-enabled ratio being a ratio of one or more successful recognitions using an image captured with the target model as a subject.
4. The information control system according to supplementary note 3, wherein
   the projection condition determination unit holds attribute-lighting frequency information associating the attribute information with the lighting frequency of each of the first to M-th lighting fixtures, and
   the attribute-lighting frequency information is information predetermined based on the relation.
5. The information control system according to supplementary note 4, wherein
   the attribute-lighting frequency information is information predetermined based on the relation acquired by a trial or information predetermined by statistically processing the relation.
6. The information control system according to supplementary note 4 or 5, wherein
   the projection condition determination unit includes:
      a determination unit that determines whether attribute information of the target is included in the attribute-lighting frequency information;
      a first projection determination unit that, in a case of determining inclusion in the attribute-lighting frequency information, determines the projection condition including the lighting frequency associated with attribute information of the target; and
      a second projection determination unit that, in a case of determining noninclusion in the attribute-lighting frequency information, determines a predetermined default condition to be the projection condition, wherein
   content of the default condition is to cause each of the first to M-th lighting fixtures to project light onto the target at a same lighting frequency.
7. The information control system according to supplementary note 3, wherein
   the projection condition determination unit determines the projection condition for the target by using a learning model for finding a projection condition of the first to M-th lighting fixtures for a target with the attribute information as an input.
8. The information control system according to any one of supplementary notes 1 to 7, wherein
   the attribute information acquisition unit includes a first acquisition unit that estimates an eye position of the target, based on an image in which the target is captured, and
   the attribute information includes an eye position of the target.
9. The information control system according to supplementary note 8, wherein
   the attribute information acquisition unit further includes a second acquisition unit that acquires attribute information of the target, based on an image in which the target is captured, and
   the attribute information further includes information about at least one of a height and a wearing article of the target.
10. The information control system according to supplementary note 9, wherein
   the wearing article is eyewear, and
   information about a wearing article of the target includes at least one of a position, a range, an angle, and a size of eyewear on a face of the target.
11. The information control system according to supplementary note 9 or 10, wherein
   the wearing article is a mask, and
   information about a wearing article of the target includes a shape type of mask worn by the target.
12. The information control system according to any one of supplementary notes 8 to 11, wherein
   the attribute information includes information about at least one of a line-of-sight direction and a face direction of the target.
13. The information control system according to any one of supplementary notes 8 to 12, wherein
   the projection condition determination unit determines the projection condition, based on the attribute information and the image capture environment.
14. The information control system according to any one of supplementary notes 8 to 13, further including:
   an iris image capture apparatus for capturing an image of an iris of the target through an image capture mirror; and
   the first to M-th lighting fixtures provided in such a way that projection directions of the lighting fixtures toward the target are different from each other.
15. The information control system according to supplementary note 14, further including
   an image capture direction control unit that controls an image capture direction of the iris image capture apparatus, based on the estimated eye position.
16. The information control system according to supplementary note 15, further including:
   an image capture mirror for changing an image capture direction of the iris image capture apparatus; and
   an image capture drive mechanism for changing a direction of the image capture mirror, wherein
   the image capture drive mechanism includes an image capture motor for changing a direction of the image capture mirror, and
   the image capture direction control unit controls an image capture direction of the iris image capture apparatus by controlling the image capture motor.
17. The information control system according to any one of supplementary notes 8 to 16, further including
   first to M-th lighting control units that control the first to M-th lighting drive mechanisms, respectively, in accordance with the determined projection condition, wherein
   the projection condition determination unit determines the projection condition including a projection direction of light from each of the first to M-th lighting fixtures, based on the estimated eye position.
18. The information control system according to supplementary note 17, further including
   first to M-th lighting drive mechanisms for changing a projection direction of each of the first to M-th lighting fixtures, wherein
   each of the first to M-th lighting fixtures projects light from a light-emitting device provided on a substrate or light from a light-emitting unit through a lighting mirror onto the target,
   the first to M-th lighting drive mechanisms respectively include the first to M-th lighting motors each for changing a direction of the substrate or the lighting mirror, and
   the first to M-th lighting control units control projection directions of the first to M-th lighting drive mechanisms by respectively controlling the first to M-th lighting motors.
19. An information processing apparatus including:
   an attribute information acquisition unit that acquires attribute information of a target; and
   a projection condition determination unit that determines a projection condition of first to M-th lighting fixtures (where M is an integer equal to or greater than 2) projecting light for capturing an image of the target onto the target, based on the attribute information, wherein
   the projection condition includes a lighting frequency of each of the first to M-th lighting fixtures.
20. An information control method including, by one or more computers:
   acquiring attribute information of a target; and
   determining a projection condition of first to M-th lighting fixtures (where M is an integer equal to or greater than 2) projecting light for capturing an image of the target onto the target, based on the attribute information, wherein
   the projection condition includes a lighting frequency of each of the first to M-th lighting fixtures.
21. The information control method according to supplementary note 20, wherein
   the first to M-th lighting fixtures are provided in such a way that projection directions of the lighting fixtures toward the target are different from each other, and,
   in determination of the projection condition, the projection condition causing the first to M-th lighting fixtures to be in different lighting states in each of a plurality of image captures of the target is determined.
22. The information control method according to supplementary note 20 or 21, wherein,
   in determination of the projection condition, the projection condition based on the attribute information is determined by using a relation among attribute information of a target model, lighting states of the first to M-th lighting fixtures, and a recognition-enabled ratio being a ratio of one or more successful recognitions using an image captured with the target model as a subject.
23. The information control method according to supplementary note 22, wherein,
   in determination of the projection condition, attribute-lighting frequency information associating the attribute information with the lighting frequency of each of the first to M-th lighting fixtures is held, and
   the attribute-lighting frequency information is information predetermined based on the relation.
24. The information control method according to supplementary note 23, wherein
   the attribute-lighting frequency information is information predetermined based on the relation acquired by a trial or information predetermined by statistically processing the relation.
25. The information control method according to supplementary note 22 or 23, wherein
   determination of the projection condition includes:
      determining whether attribute information of the target is included in the attribute-lighting frequency information;
      in a case of determining inclusion in the attribute-lighting frequency information, determining the projection condition including the lighting frequency associated with attribute information of the target; and,
      in a case of determining noninclusion in the attribute-lighting frequency information, determining a predetermined default condition to be the projection condition, and
   content of the default condition is to cause each of the first to M-th lighting fixtures to project light onto the target at a same lighting frequency.
26. The information control method according to supplementary note 22, wherein,
   in determination of the projection condition, the projection condition for the target is determined by using a learning model for finding a projection condition of the first to M-th lighting fixtures for a target with the attribute information as an input.
27. The information control method according to any one of supplementary notes 20 to 26, wherein
   acquisition of the attribute information includes estimating an eye position of the target, based on an image in which the target is captured, and
   the attribute information includes an eye position of the target.
28. The information control method according to supplementary note 27, wherein
   acquisition of the attribute information further includes acquiring attribute information of the target, based on an image in which the target is captured, and
   the attribute information further includes information about at least one of a height and a wearing article of the target.
29. The information control method according to supplementary note 28, wherein
   the wearing article is eyewear, and
   information about a wearing article of the target includes at least one of a position, a range, an angle, and a size of eyewear on a face of the target.
30. The information control method according to supplementary note 28 or 29, wherein
   the wearing article is a mask, and
   information about a wearing article of the target includes a shape type of mask worn by the target.
31. The information control method according to any one of supplementary notes 27 to 30, wherein
   the attribute information includes information about at least one of a line-of-sight direction and a face direction of the target.
32. The information control method according to any one of supplementary notes 27 to 31, wherein,
   in determination of the projection condition, the projection condition is determined based on the attribute information and the image capture environment.
33. The information control method according to any one of supplementary notes 27 to 32, wherein
   the one or more computers are connected to:
      an iris image capture apparatus for capturing an image of an iris of the target through an image capture mirror; and
      the first to M-th lighting fixtures provided in such a way that projection directions of the lighting fixtures toward the target are different from each other.
34. The information control method according to supplementary note 33, further including
   controlling an image capture direction of the iris image capture apparatus, based on the estimated eye position.
35. The information control method according to supplementary note 34, wherein
   the at least one computer is further connected to an image capture drive mechanism for changing a direction of an image capture mirror for changing an image capture direction of the iris image capture apparatus,
   the image capture drive mechanism includes an image capture motor for changing a direction of the image capture mirror, and,
   in control of the image capture direction, an image capture direction of the iris image capture apparatus is controlled by controlling the image capture motor.
36. The information control method according to any one of supplementary notes 27 to 35, further including
   controlling the first to M-th lighting drive mechanisms in accordance with the determined projection condition, wherein,
   in determination of the projection condition, the projection condition including a projection direction of light from each of the first to M-th lighting fixtures is determined based on the estimated eye position.
37. The information control method according to supplementary note 36, wherein
   the at least one computer is further connected to first to M-th lighting drive mechanisms for changing a projection direction of each of the first to M-th lighting fixtures,
   each of the first to M-th lighting fixtures projects light from a light-emitting device provided on a substrate or light from a light-emitting unit through a lighting mirror onto the target,
   the first to M-th lighting drive mechanisms respectively include the first to M-th lighting motors each for changing a direction of the substrate or the lighting mirror, and,
   in control of the first to M-th lighting drive mechanisms, projection directions of the first to M-th lighting drive mechanisms are controlled by controlling the first to M-th lighting motors, respectively.
38. A medium on which a program is recorded, the program causing one or more computers to execute:
   acquiring attribute information of a target; and
   determining a projection condition of first to M-th lighting fixtures (where M is an integer equal to or greater than 2) projecting light for capturing an image of the target onto the target, based on the attribute information, wherein
   the projection condition includes a lighting frequency of each of the first to M-th lighting fixtures.
39. The medium on which the program according to supplementary note 38 is recorded, wherein
   the first to M-th lighting fixtures are provided in such a way that projection directions of the lighting fixtures toward the target are different from each other, and,
   in determination of the projection condition, the projection condition causing the first to M-th lighting fixtures to be in different lighting states in each of a plurality of image captures of the target is determined.
40. The medium on which the program according to supplementary note 38 or 39 is recorded, wherein,
   in determination of the projection condition, the projection condition based on the attribute information is determined by using a relation among attribute information of a target model, lighting states of the first to M-th lighting fixtures, and a recognition-enabled ratio being a ratio of one or more successful recognitions using an image captured with the target model as a subject.
41. The medium on which the program according to supplementary note 40 is recorded, wherein,
   in determination of the projection condition, attribute-lighting frequency information associating the attribute information with the lighting frequency of each of the first to M-th lighting fixtures is held, and
   the attribute-lighting frequency information is information predetermined based on the relation.
42. The medium on which the program according to supplementary note 41 is recorded, wherein
   the attribute-lighting frequency information is information predetermined based on the relation acquired by a trial or information predetermined by statistically processing the relation.
43. The medium on which the program according to supplementary note 40 or 41 is recorded, wherein
   determination of the projection condition includes:
      determining whether attribute information of the target is included in the attribute-lighting frequency information;
      in a case of determining inclusion in the attribute-lighting frequency information, determining the projection condition including the lighting frequency associated with attribute information of the target; and,
      in a case of determining noninclusion in the attribute-lighting frequency information, determining a predetermined default condition to be the projection condition, and
   content of the default condition is to cause each of the first to M-th lighting fixtures to project light onto the target at a same lighting frequency.
44. The medium on which the program according to supplementary note 40 is recorded, wherein,
   in determination of the projection condition, the projection condition for the target is determined by using a learning model for finding a projection condition of the first to M-th lighting fixtures for a target with the attribute information as an input.
45. The medium on which the program according to any one of supplementary notes 38 to 44 is recorded, wherein
   acquisition of the attribute information includes estimating an eye position of the target, based on an image in which the target is captured, and
   the attribute information includes an eye position of the target.
46. The medium on which the program according to supplementary note 45 is recorded, wherein
   acquisition of the attribute information further includes acquiring attribute information of the target, based on an image in which the target is captured, and
   the attribute information further includes information about at least one of a height and a wearing article of the target.
47. The medium on which the program according to supplementary note 46 is recorded, wherein
   the wearing article is eyewear, and
   information about a wearing article of the target includes at least one of a position, a range, an angle, and a size of eyewear on a face of the target.
48. The medium on which the program according to supplementary note 46 or 47 is recorded, wherein
   the wearing article is a mask, and
   information about a wearing article of the target includes a shape type of mask worn by the target.
49. The medium on which the program according to any one of supplementary notes 45 to 48 is recorded, wherein
   the attribute information includes information about at least one of a line-of-sight direction and a face direction of the target.
50. The medium on which the program according to any one of supplementary notes 45 to 49 is recorded, wherein,
   in determination of the projection condition, the projection condition is determined based on the attribute information and the image capture environment.
51. The medium on which the program according to any one of supplementary notes 46 to 50 is recorded, wherein
   the one or more computers are connected to:
      an iris image capture apparatus for capturing an image of an iris of the target through an image capture mirror; and
      the first to M-th lighting fixtures provided in such a way that projection directions of the lighting fixtures toward the target are different from each other.
52. The medium on which the program according to supplementary note 51 is recorded, further causing the one or more computers to execute
   controlling an image capture direction of the iris image capture apparatus, based on the estimated eye position.
53. The medium on which the program according to supplementary note 52 is recorded, wherein
   the at least one computer is further connected to an image capture drive mechanism for changing a direction of an image capture mirror for changing an image capture direction of the iris image capture apparatus,
   the image capture drive mechanism includes an image capture motor for changing a direction of the image capture mirror, and,
   in control of the image capture direction, an image capture direction of the iris image capture apparatus is controlled by controlling the image capture motor.
54. The medium on which the program according to any one of supplementary notes 45 to 53 is recorded, further causing the one or more computers to execute:
   controlling the first to M-th lighting drive mechanisms in accordance with the determined projection condition, wherein,
   in determination of the projection condition, the projection condition including a projection direction of light from each of the first to M-th lighting fixtures is determined based on the estimated eye position.
55. The medium on which the program according to supplementary note 54 is recorded, wherein
   the at least one computer is further connected to first to M-th lighting drive mechanisms for changing a projection direction of each of the first to M-th lighting fixtures,
   each of the first to M-th lighting fixtures projects light from a light-emitting device provided on a substrate or light from a light-emitting unit through a lighting mirror onto the target,
   the first to M-th lighting drive mechanisms respectively include the first to M-th lighting motors each for changing a direction of the substrate or the lighting mirror, and,
   in control of the first to M-th lighting drive mechanisms, projection directions of the first to M-th lighting drive mechanisms are controlled by controlling the first to M-th lighting motors, respectively.

### REFERENCE SIGNS LIST

100, 200, 300, 400 Information processing system
101 Detection unit
102 Wide-area image capture apparatus
103 Information processing apparatus
105 Iris image capture apparatus
106 Image capture mirror
107 Image capture drive mechanism
108a First lighting fixture
108b Second lighting fixture
109a First lighting drive mechanism
109b Second lighting drive mechanism
111 Detection control unit
112 Attribute information acquisition unit
112a First acquisition unit
112b Second acquisition unit
113, 213, 313, 413 Projection condition determination unit
113a, 313a Determination unit
113b, 313b First projection determination unit
113c, 313c Second projection determination unit
114 Image capture control unit
115 Image capture direction control unit
116a First lighting control unit
116b Second lighting control unit
321 Environment sensor
322 Environmental information acquisition unit

What is claimed is:

1. An information processing system comprising:
at least one memory configured to store instructions; and
at least one processor configured to execute the instructions to:
acquire attribute information of a target; and
determine a projection condition of first to M-th lighting fixtures (where M is an integer equal to or greater than 2) projecting light for capturing an image of the target onto the target, based on the attribute information, wherein
the projection condition includes a lighting frequency of each of the first to M-th lighting fixtures, and
the first to M-th lighting fixtures are provided in such a way that projection directions of the lighting fixtures toward the target are different from each other.

2. The information processing system according to claim 1, wherein
the first to M-th lighting fixtures are provided in such a way that projection directions of the lighting fixtures toward the target are different from each other.

3. The information processing system according to claim 1, wherein
in determination of the projection condition, the projection condition based on the attribute information is determined by using a relation among attribute information of a target model, lighting states of the first to M-th lighting fixtures, and a recognition-enabled ratio being a ratio of one or more successful recognitions using an image captured with the target model as a subject.

4. The information processing system according to claim 3, wherein
in determination of the projection condition, attribute-lighting frequency information associating the attribute information with the lighting frequency of each of the first to M-th lighting fixtures is held, and
the attribute-lighting frequency information is information predetermined based on the relation.

5. The information processing system according to claim 4, wherein
the attribute-lighting frequency information is information predetermined based on the relation acquired by a trial or information predetermined by statistically processing the relation.

6. The information processing system according to claim 4, wherein
determination of the projection condition includes:
determining whether attribute information of the target is included in the attribute-lighting frequency information;
in a case of determining inclusion in the attribute-lighting frequency information, determining the projection condition including the lighting frequency associated with attribute information of the target; and
in a case of determining noninclusion in the attribute-lighting frequency information, determining a predetermined default condition to be the projection condition, wherein
content of the default condition is to cause each of the first to M-th lighting fixtures to project light onto the target at a same lighting frequency.

7. The information processing system according to claim 3, wherein
in determination of the projection condition, the projection condition for the target is determined by using a learning model for finding a projection condition of the first to M-th lighting fixtures for a target with the attribute information as an input.

8. The information processing system according to claim 1, wherein
acquisition of the attribute information includes estimating an eye position of the target, based on an image in which the target is captured, and
the attribute information includes an eye position of the target.

9. The information processing system according to claim 8, wherein the unit
acquisition of the attribute information further includes acquiring attribute information of the target, based on an image in which the target is captured, and
the attribute information further includes information about at least one of a height and a wearing article of the target.

10. The information processing system according to claim 9, wherein
the wearing article is eyewear, and
information about a wearing article of the target includes at least one of a position, a range, an angle, and a size of eyewear on a face of the target.

11. The information processing system according to claim 9, wherein
the wearing article is a mask, and
information about a wearing article of the target includes a shape type of mask worn by the target.

12. The information processing system according to claim 8, wherein
the attribute information includes information about at least one of a line-of-sight direction and a face direction of the target.

13. The information processing system according to claim 8, wherein
in determination of the projection condition, the projection condition is determined based on the attribute information and the image capture environment.

14. The information processing system according to claim 8, wherein at least one processor configured further to execute the instructions to:
capture an image of an iris of the target through an image capture mirror; and wherein
the first to M-th lighting fixtures provided in such a way that projection directions of the lighting fixtures toward the target are different from each other.

15. The information processing system according to claim 14, wherein at least one processor configured further to execute the instructions to:
control an image capture direction of the iris image capture apparatus, based on the estimated eye position.

16. The information processing system according to claim 15, further comprising:
an image capture mirror for changing an image capture direction of the iris image capture apparatus; and
an image capture drive mechanism for changing a direction of the image capture mirror, wherein
the image capture drive mechanism includes an image capture motor for changing a direction of the image capture mirror, and
in control of the image capture direction, an image capture direction of the iris image capture apparatus is controlled by controlling the image capture motor.

17. The information processing system according to claim 8, wherein at least one processor configured further to execute the instructions to:
control the first to M-th lighting drive mechanisms, respectively, in accordance with the determined projection condition, wherein
determine the projection condition including a projection direction of light from each of the first to M-th lighting fixtures, based on the estimated eye position.

18. The information processing system according to claim 17, wherein
the at least one processor is further connected to first to M-th lighting drive mechanisms for changing a projection direction of each of the first to M-th lighting fixtures,
each of the first to M-th lighting fixtures projects light from a light-emitting device provided on a substrate or light from a light-emitting device through a lighting mirror onto the target,
the first to M-th lighting drive mechanisms respectively include the first to M-th lighting motors each for changing a direction of the substrate or the lighting mirror, and
in control of the first to M-th lighting drive mechanisms, projection directions of the first to M-th lighting drive mechanisms are controlled by controlling the first to M-th lighting motors, respectively.

19. (canceled)

20. An information processing method comprising, by one or more computers:
acquiring attribute information of a target; and
determining a projection condition of first to M-th lighting fixtures projecting light for capturing an image of the target onto the target from different projection directions each other, based on the attribute information, M being an integer equal to or greater than 2, wherein
the projection condition includes a lighting frequency of each of the first to M-th lighting fixtures.

21. A non-transitory computer readable medium on which a program is recorded, the program causing one or more computers to execute:
acquiring attribute information of a target; and
determining a projection condition of first to M-th lighting fixtures projecting light for capturing an image of the target onto the target from different projection directions each other, based on the attribute information, M being an integer equal to or greater than 2, wherein
the projection condition includes a lighting frequency of each of the first to M-th lighting fixtures.
